(19) United States
(12) Patent Application Publication
(10) Pub. No.: US 2010/0309310 A1
(43) Pub. Date: Dec. 9, 2010

(54) AIRCRAFT MONITORING AND IDENTIFICATION SYSTEM

(76) Inventor: Dale ALBRIGHT, Louisburg, NC (US)

Correspondence Address: Ishman Law Firm P.C., P.O BOX 1297, Holly Springs, NC, 27540-1297, US

(21) Appl. No.: 11/963,890

(22) Filed: Dec. 24, 2007

Related U.S. Application Data
(60) Provisional application No. 60/912,864, filed on Apr. 19, 2007.

(51) Int. Cl. H04N 7/18

(52) U.S. Cl. 348/135; 348/143; 348/E07.085

(57) ABSTRACT

An aircraft tail number identification system for detecting, identifying, capturing, decoding, and recording pictures of all arriving and departing aircraft on airport pathways, 24 hours a day, 7 days a week, in all kind of weather.

### RELATED APPLICATION

This application claims the benefit of U.S. Provisional Application No. 60/912,864 filed on Apr. 19, 2007 in the name of Dale Albright and entitled “Aircraft Tail Number Identification System”.

### FIELD OF THE INVENTION

The present invention relates to aircraft monitoring and, in particular, to a system for documenting aircraft traffic through the identifying the tail number of aircraft at a facility.

### BACKGROUND OF THE INVENTION

In the post 9/11 world, it was recognized that greater security had to be established at airports serving both national and international planes and passengers. To this end, passenger screening and monitoring throughout the airport complex is common, employing extensive personnel and equipment. Additional scrutiny is directed toward airport personnel and equipment as well as airport perimeters and support facilities. To reduce personnel cost and improve accountability, passive surveillance systems have been proposed for remotely observing airport activities and forwarding the results to a facility location for processing.

Surveillance systems such as disclosed in U.S. Pat. No. 6,545,601 to Monroe wherein a comprehensive multi-media safety, tracking and/or surveillance system uses visual and audio information, which is collected and relayed, to a monitoring center at the airport.

While such costs can be borne by larger facilities, smaller facilities such as General Aviation Airports have lesser resources and are normally only attended during a portion of the day, usually from sunup to sundown. Security is nonetheless taken seriously and ground and perimeter surveillance monitoring employed to supplement visual observations. One area, however, where limited information is garnered is the arrival and departures of aircraft. The aircraft using the airport may be based thereat or transient, domestic and foreign, arriving and departing the airport without a flight plan. During hours of attended operation, the traffic may be observed but is rarely documented other than through receipts from facility services and landing fees, if any. During off hours, the planes may arrive and depart with no formal notice or documentation. From a security and law enforcement standpoint, this can create potential problems. The planes could carry passengers and/or cargo posing a danger to airport operations and/or surrounding environs. Even though the plane and passengers may be on watch lists from other enforcement agencies, such coincidence may not be noted, particularly during unattended periods. Passive surveillance and identification of aircraft has been proposed, but require complex and expensive equipment beyond the means of the smaller facilities. Even at larger airports, the traffic at the general aviation sector is limitedly monitored.

One potential basis for identification is the unique number assigned throughout the world to registered aircraft, commonly referred to as the tail number, which may appear at various parts including the tail on both sides thereof. In one approach as disclosed in U.S. Pat. No. 5,375,058 to Bass, a detection system is proposed wherein machine readable codes are scanned by sensors to in part identify the aircraft and its position at the facility for report to the control tower. Notwithstanding the prohibitive costs for implementation, the machine readable code is not presently utilized and would require regulatory mandates for adoption, a lengthy and problematic outcome. Other surveillance systems such as disclosed in U.S. Pat. No. 6,545,601 to Monroe utilize aircraft based transmitters that provide, among other things, the tail number to a monitoring station for identification. Other sensors disposed at locations around the airport report conditions proximate the aircraft. Such a system is intended for commercial fleets and requires onboard equipment not presently available or affordable for general aviation facilities and aircraft.

It would accordingly be desirable to provide a full time surveillance system for monitoring aircraft arrivals and departures, particularly at smaller facilities, that could be incorporated into security programs without aircraft modification and elaborate facility infrastructure. Such a system would detect, identify, capture, decode, and record pictures of all arriving and departing aircraft 24 hours a day, 7 days a week, in all kinds of weather, and produce electronic alerts of aircraft on watch. Such a system would operate reliably under the operational conditions experienced at airport facilities including lack of protection from the weather and other severe environmental conditions; false triggering events due to detection of distant aircraft movements on parallel runways, environmental and other extraneous conditions such as rain, snow, animals, lightning, high weeds, etc.; and lack of power in remote areas. Such a capability would also yield ancillary benefits to the facility through documentation for government funding based on traffic, landing fees based on continuous assessment and with accurate identification of ownership even for transient aircraft; and noise abatement enabled by correlation of time and aircraft.

### SUMMARY OF THE INVENTION

In the present invention, an Aircraft Tail Number Identification System (ATNIS) interfaces with a Wireless Airport Surveillance Platform (WASP) to detect, identify, capture, decode and record aircraft tail numbers and unique physical characteristics, on a continuous basis, and produce electronic alerts on watch-listed aircraft and plane traffic information for the served airport. The system utilizes video cameras, passive infrared sensors, photo sensors, analogue-to-digital video encoding devices, video (pixel) motion analysis, image decoding algorithms, infrared illuminators, wireless radios and a single board computer (SBC) combined together to detect, day or night, and record a series of pictures, as a time stamped video record, the identity of the aircraft and its registration number and unique physical characteristics. The images are transmitted via wireless using Secure File Transfer Protocol (SFTP) to a local site computer and then transferred via a secure internet connection to the WASP central mainframe computer for processing. The processing analyzes and documents the recordings, issues alerts to authorized parties and provides documentation of airport plane and incursion traffic.

In one aspect, the invention provides a system for identifying on a continuous basis by tail number aircraft traveling along a pathway at an airport facility wherein sensor means positioned adjacent said pathway detect the presence of an aircraft on the pathway within a detection zone; illuminating means illuminate the aircraft on the pathway within said detection zone in response to the detecting if ambient lighting is below a predetermined level; video recording means record the aircraft including the tail number of the detected aircraft and imbedding an indication of the recording time therein; and the recording is transferred to a remote facility for storage and analysis. Such an analysis may be performed to identify aircraft on watch or alert lists, established locally or globally, report the airport traffic activity for use is assessing fees and obtaining funding, and assisting identification of aircraft excessive noise or other troublesome activities to the population surrounding the facility.

In another aspect, the present invention provides a detection system for alpha-numeric tail numbers on aircraft traveling a detection location on a path at a facility indicative of a departure or arrival of the aircraft wherein a camera unit directed at the path photographs the tail number of the aircraft at the detection location, motion detection means detect the aircraft on the path prior to the detection location; light detection means determine light conditions at the detection location; illumination means associated with the light detection means and the motion detection means provide illumination of aircraft detected by the detection means if the light conditions are below a predetermined level; control means enable the camera unit for capturing a series of photographic images of the aircraft and associated tail number as the aircraft traverses said detection location; and the images are transmitted to a remote location for processing.

In another aspect, the present invention provides a detection system for the physical characteristics of aircraft traveling a detection location on a path at a facility indicative of a departure or arrival of the aircraft wherein a camera unit directed at the path photographs the aircraft at the detection location, motion detection means detect the aircraft on the path prior to the detection location; light detection means determine light conditions at the detection location; illumination means associated with the light detection means and the motion detection means provide illumination of aircraft detected by the detection means if the light conditions are below a predetermined level; control means enable the camera unit for capturing a series of photographic images of the aircraft and associated physical identifying characteristics as the aircraft traverses said detection location; and the images are transmitted to a remote location for processing. Physical characteristics of aircraft may include: wing placement, tail configuration, type of landing gear, number and type of engine(s), color(s), location of registration number, and other visually identifiable characteristics.

In a further aspect, the present invention provides a surveillance system for notifying an authorized party of the presence of an aircraft on an itemized list at a detection location on a path at an airport facility wherein a video image of the aircraft is obtained at the detection location and transmitted to a monitoring location for determination based on the video image if the aircraft may be on the itemized list, and if present on the itemized list notifying the authorized party. The itemized list may include physical characteristics and identifying indicia regarding the aircraft thereon and based on a comparison of said video image with said physical characteristics and identifying indicia. The identifying indicia may include at least a partial designation of the alphanumeric tail number of the aircraft or a complete correspondence between the aircraft at the facility and the aircraft on the itemized list. Similarly, the physical characteristics may include at least a partial match of the aircraft or a complete correspondence between the aircraft at the facility and the aircraft on the itemized list. The video image is at least one remote unit located at a location at the facility indicative of an arrival and/or departure of the aircraft and said video image includes a time said video image was obtained. The system may include a plurality of remote units located at the facility at positions assuring that at least one video image is obtained of aircraft arriving at or departing from the facility. The system may include a plurality of facilities with associated base units and wherein said monitoring location sequentially processes said video images.

In another aspect, the present invention provides a monitoring system for documenting arrivals and departures of aircraft from a facility wherein a plurality of video recording means at said facility are located corresponding to available arrival and departure sites; means detect the aircraft moving toward said site; light detection means determine light conditions at said detection location; illumination means associated with the light detection means and said motion detection means for providing illumination of aircraft detected by said detection means if said light conditions are below a predetermined level; control means enable the recording means for capturing a series of photographic images of said aircraft and associated tail number as the aircraft traverses said detection location; means provide wireless transmission of the images to a remote location for processing; and means at said remote location analyze said images and provide said facility with documentation of the tail numbers of aircraft arriving and departing said facility on periodic intervals. The documentation may distinguish between aircraft based at said facility on aircraft transient to said facility.

Accordingly, it is an object to provide a full time surveillance system that records arrivals and departures of aircraft in real time and alerts law enforcement agencies of detected aircraft on alert status.

Another object is to provide an aircraft monitoring system that provides an accurate accounting of identified aircraft departures and arrivals for airport billing and funding purposes.

Another object is to provide a system that visually documents all incoming and outgoing traffic at smaller, limitedly and intermittently staffed airport facilities.

### BRIEF DESCRIPTION OF THE DRAWINGS

The above and other features and advantages of the invention will become apparent upon reading the following description taken in conjunction with the accompanying drawings in which:

FIG. 1 is a schematic diagram of an aircraft tail number identification system interfaced with a wireless airport surveillance system;

FIG. 2 is a perspective view of the remote unit for the identification system;

FIG. 3 is a schematic diagram of the remote unit;

FIG. 4 is a software flow diagram for the identification system;

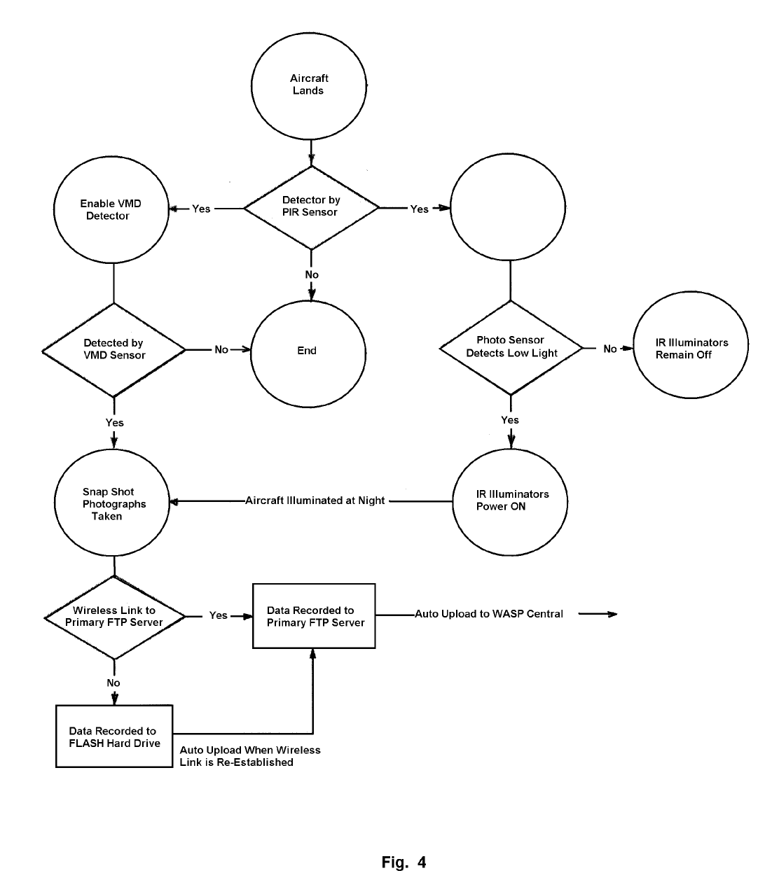

FIG. 5 is a schematic block diagram of monitoring and identification system; and

FIG. 6 is a schematic block diagram of the platform alert.

### DETAILED DESCRIPTION OF THE PREFERRED EMBODIMENT

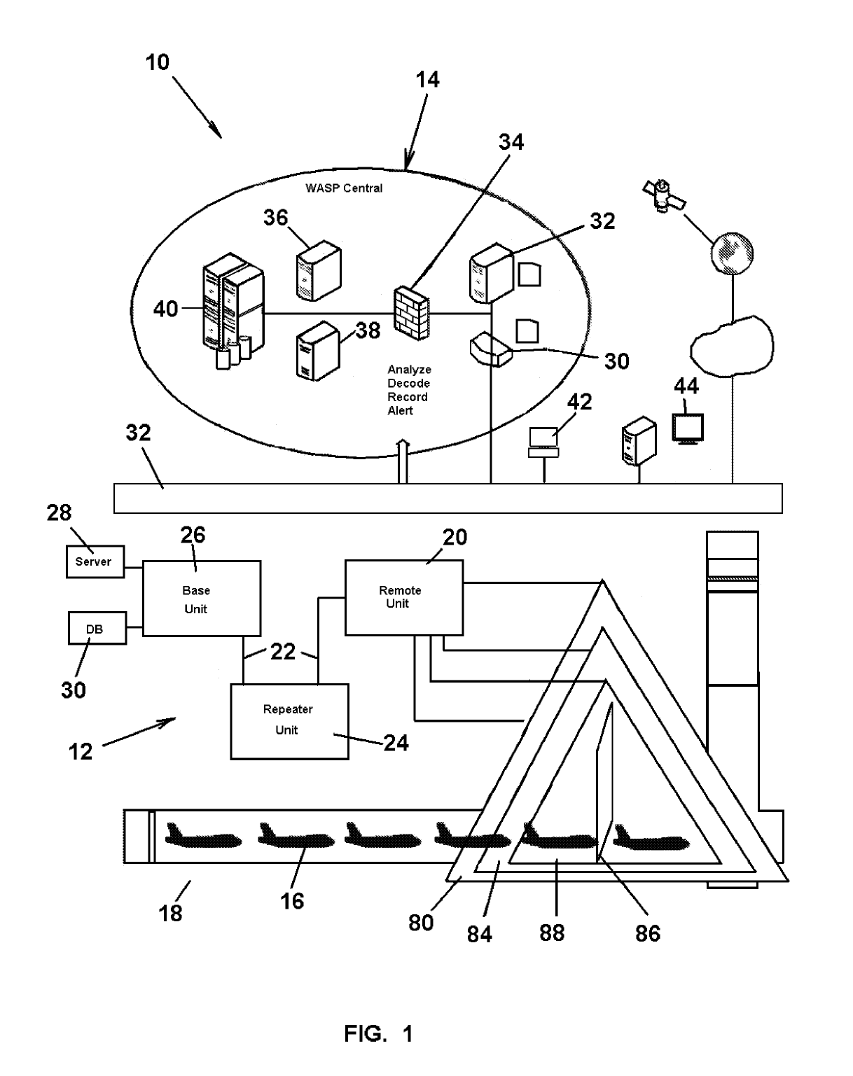

Referring to FIG. 1, an aircraft monitoring and identification system 10 includes a tail number information system (ATNIS) 12 at an airport that interfaces with a central remote wireless airport surveillance platform (WASP) 14 to detect, identify, capture, decode, and record pictures of all arriving and departing aircraft 16 on airport pathways 18. Based on transferred information thereon, the platform 14 produces electronic alerts of aircraft on watch to authorized parties and reports on detected aircraft activity to interested parties, such as the local airport. The ANTIS system 12 includes free standing remote stations or units 20 positioned at various key locations, such as taxiways and connectors, on the available airport traffic pathways for detecting arrivals and departure movements. A multiplicity of remote stations may be used, dependent on the complexity of the available traffic patterns. The system will be described with reference to a single remote unit for purposes of the present disclosure.

The remote unit 20 transfers data by wireless connection 22 through a repeater unit 24 to a local base station or unit 26 including a server 28 and an associated local data base 30, which then transfers the data files to the platform 14 through the Internet 32. The repeater unit 24 is desirable for signal continuity if the base unit 26 is distant from the remote unit 20, outside a line of sight transmission; obscured by buildings, terrains and other obstructions; or subject to interference signals. Otherwise, the repeater unit 24 is optional.

The remote unit 20 accepts triggered input from sensors and video cameras and transmits the video information either directly to the base unit 26 or indirectly through the repeater unit 24 upon sensing certain conditions as described below. Either digital or analog cameras may be provided in the remote unit. For analog cameras the output is fed to a built-in encoder that digitizes the video information. For digital cameras an encoder is not required. For both types, the resultant digital video information is fed to built-in radio transceivers that transmit, directly or indirectly, the information using OFDM modulation to the base unit 26. The camera may be either fixed position or variable position such as remotely controlled Pan Tilt Zoom (PTZ) cameras. The remote units may be equipped for handling one or more cameras.

The base unit 26 is preferably locally based within ten miles of the remote units, provided the same are in near-line-of-sight (NLOS) or connected with repeater units if obstructions are interposed. The output of the base unit 26 is normally connected to the local computer server 28 and associated database 30. The server 28 functions as a Network Video Recorder (NVR) and pre-processes, filters and stores images of detected events. The base unit can also be connected to a computer network, or other IP Internet device.

The repeater units 24 are used for situations wherein it is necessary to extend the distance of the network, for example because of obstruction from buildings, tree, terrain and the like that prevent line of sight communication between the remote unit and the base unit. A typical repeater unit would include one or more radios and corresponding antennas.

Decoder units are incorporated in the remote units in situations where an analog video output stream is required from one or more cameras at remote locations. Where so configured, a radio and antenna receives the digital signal and a decoder converts the signal to an analog video stream. The remote station can be configured to accommodate one or more decoder units.

The units for the ANTIS system 12 operate in a network of wireless interfaces configured with a unique IP address, frequency, set service identifier (SSID), communication protocol, media access control (MAC) address of connected units and other parameters so that all units will automatically link when powered on. The Ethernet interfaces are configured with a unique IP address and DHCP server that is programmed to give a connected device, such as a camera or computer, a unique address such that the head-end Server equipment (NVR) recognizes the IP address of remote connected devices.

In the network, the base unit 26 is configured as a NTP (Network Time Protocol) client and server. In the client mode, the base unit synchronizes its clock with WASP Central. In the server mode, the base unit will automatically distribute time to all of the remote units and also to direct connected devices (NVR) and remote connected devices, camera. Accordingly, all devices in the network are synchronized. The entire WASP system is adjusted to Greenwich Mean Time. A text configuration script and full backup file are included on each unit such that in the event of a disaster, a pre-programmed and configured replacement can be made immediately.

The ANTIS system can operate as a stand-alone system or can be configured for connection to an existing IP network. As a stand alone, the system can: detect motion events; send automatic email alerts; view live video; search for recorded events by time and date; upload images using FTP, file transfer protocol; remotely log in using Virtual Private Networking protocol secure address; enable password protection with user login accounts; and link to a centralized monitoring facility allowing for remote access for network management and upgrades. The system is dual-password protected and can be remotely accessed by specified personnel via encrypted Virtual Private Network (VPN) connection using a standard web browser on a desktop or laptop PC.

The base unit 26 provides the central point of access to the remote unit(s) 20 and connects to the Internet 32 via 10/100 Mbit Ethernet. The base unit 26 is configured with a single board computer, up to two radio modules, and in some cases may also be configured with up to two video encoders or decoders to allow video input or output. A secondary radio may be configured as an additional base station radio for the video network or as a local wireless access point to allow mobile wireless access for airport personnel and law enforcement. The local base station provides network management functions such as routing, packet filtering, encryption, bandwidth control, time synchronization, network monitoring, access control and VPN.

At the WASP platform 14, the data is directed by router 30 to a proxy server 32 and through secure firewall 34 to the main servers 36, 38 and to a data storage database 40. At the servers 36, 38, the data is analyzed, decoded and recorded by software and monitoring personnel. If warranted based on watch list correlation, an alert is issued globally to authorized parties 42. Periodically, reports are issued to authorized parties 44 of the airport operator for documenting facility traffic. The reports may additionally differentiate home-based and transient aircraft.

The platform 14 is a centrally monitored communications and video network functioning as an open source web based hosted platform. The servers 36, 38 are continuously updated with images of aircraft movements throughout the nation and are periodically downloading aircraft information from sources such as the FAA database to obtain accurate aircraft information.

At the platform, operators monitor the network and manage the system. Each aircraft movement is processed with: time and date; camera number; airport code; region code; aircraft registration number; flight direction; aircraft type—including manufacturer; model; aircraft type; number and type of engines, weight and seating capacity; aircraft registrant—including name; address; city; state; zip; and transient or home-based status; wing type and placement, tail configuration; type of landing gear; primary and secondary colors; location of registration number.

The platform is a web based hosted application, dual password protected and remotely accessible anywhere in the nation by authorized airport personnel and law enforcement via encrypted VPN (Virtual Private Network) connection using a standard web browser on a desktop or laptop PC.

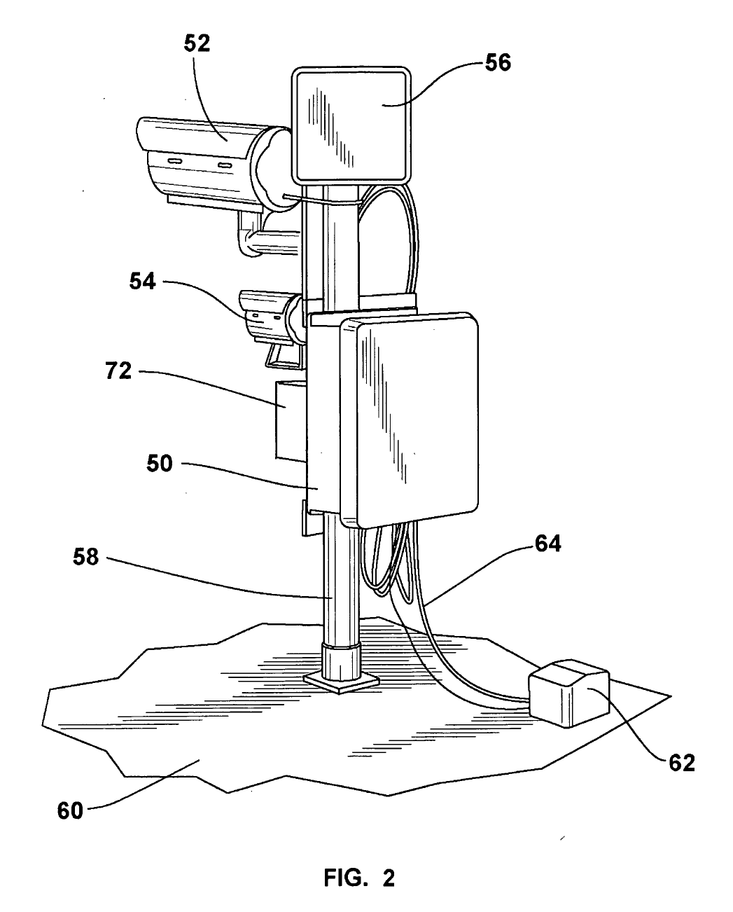

Within the network, the remote units are the primary system component for detecting aircraft and recording the alphanumeric tail numbers and aircraft characteristics thereof. Referring to FIG. 2, the remote unit 20 comprises a housing 50, an infrared (IR) illuminator 52, a camera and illuminator 54, a passive infrared sensor 72 and an antenna 56, all of which are carried on a support post and frangible coupling 58 attached to a base platform 60. The remote unit 20 is positioned with respect to a desired pathway at locations necessary for detecting an arrival or departing movement of the aircraft. Depending on the location selected, the remote unit may be mounted on existing structure and/or other support units. It is preferred to locate the remote units at a location where the aircraft is traveling at a speed allowing the capture of a series of images of needed clarity for the identification of the tail number indicia and physical characteristics. An input power supply 62 is connected to by cable 64 to an internal output power supply in the housing 50. The input power supply may be part of the airport electrical grid, or if not available, an alternative source such as a solar power supply may be provided.

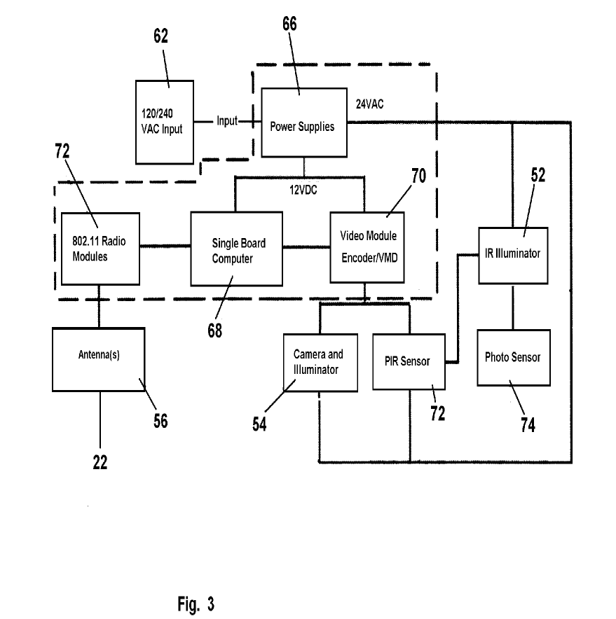

Referring to FIG. 3, the output power supplies 66 in the housing 50 supply 12 VDC to a single board computer 68 and a video module encoder/VMD 70 and 24 VAC to the camera and illuminator 52, a PIR sensor 72, and the IR illuminator 52 and an associated photo sensor 74. The computer 68 is connected with a radio module 76 and the antenna 56 for wireless communication with a receiver at a local base unit 26 at or associated with the airport.

The computer 68 is a compact high performance integrated communications platform designed for high-throughput Ethernet and wireless based networks. A Linux based Operating System provides the core functions of routing, network setup and management tools. The computer can be configured with two radio modules and compact flash or micro-drive for redundant video storage or fail-over operation. If communication to the base station goes down, the computer will continue to operate by storing aircraft images on the compact flash or micro-drive.

The PIR sensor 72 is a dual stage directional passive infrared thermal sensor. When an object is detected within the target zone, a built-in FET sensor continuously measures the amount of energy and rate of change generated by the object's thermal signature. An aircraft is detected when both sensors go active simultaneously.

The video monitor decoder encompasses a pre-defined invisible detection window within the field of view of the camera and occupies a zone where all aircraft pass through. A sensor in the decoder continuously measures the pixel change and rate of movement within the target window. An aircraft is detected when the measured movement meets a pre-calibrated level set for triggered response.

Infrared illumination is provided by two independent infrared modules: a primary infrared module is integrated with the camera and illuminator 54 in the housing: and as the secondary infrared module the stand alone self-contained illuminator 52. Both illuminators use semi-covert 850 nm LED's and are short to midrange 30° beam angles with adjustable IR intensity and photocell sensitivity. Enabling of the illuminators is determined by an associated photo sensor 74 to limit power consumption to darkness hours. The camera is a commercially available off the shelf professional quality day/night camera.

The video module encoder 70 provides analog to IP based digital video conversion, motion detection and image analysis. Using embedded software and customized programming for execution of system controls, images of detected aircraft are transmitted to the local base station at the airport computer. The image size is configurable in resolutions up to 720×480 pixels in MPEG or MPEG-4 format. Live video can be viewed using variable compressed MPEG-4 and MPEG. The system can be configured with up to two video encoders for fixed or PTZ cameras.

The radio module 72 is an Atheros AR5004 802.11 based Super Range modular mini-PCI card. The Super Range radio technology has been designed from the ground up specifically for outdoor wireless use. The radios can operate in the FCC 2.4 GHz, 4.9 GHz and 5.8 GHz bands using OFDM spread spectrum signaling for near line of site communication. Each unit can accept two radio modules that are software configured as a base station, remote station, or repeater.

The wireless link uses frequencies in the license free Industrial, Scientific and Medical (ISM) band as allowed by the Federal Communications Commission (FCC). Licensed frequencies for use by Local, State and Federal Governments as allocated by the FCC may also be used if authorized. Wireless transmission is encrypted using WPA2 encryption algorithms. All communications conform with standard Internet Protocol (TCP/IP) in order to interface seamlessly with other IP networks. Rigorous firewall rules are used in order to prevent unauthorized access to the data or the network. In order to accurately time stamp the video events, the system uses a Network Time Protocol (NTP) server to synchronize the date and time of all units.

Referring to FIG. 3, the PIR sensor 66 scans the traffic path and has a threshold that distinguishes between plane configurations and, false events such as distant aircraft movements on adjacent runways, environmental and other extraneous conditions such as rain, snow, animals, lightning, high weeds, etc. The sensor 66 is continuously operative. Upon positive detection in detection zone 80 (FIG. 1), power to the IR illuminators and VMD detector is enabled. The photo sensor 74 measures the ambient lighting conditions. If below a predetermined level, the photo sensor powers the infrared illuminator to provide illumination at the traffic path in illumination zone 82 (FIG. 1). If above the level, the illuminators remain off. Thus, the infrared illuminator is normally off and only turned on when two conditions were met; an aircraft is present, and only at night.

Briefly, while an aircraft is in the detection zone 72 (FIG. 1), the sensor output is used to perform two tasks. First, the sensor executes a script that enables a video (pixel) motion detection zone 84 (FIG. 1) which is subsequently used to detect and capture snap shot photographs at image zone 86 of the moving aircraft within the camera field of view 88. Second, the sensor activates power to the infrared illuminators 54 and 52, which are controlled by the photo sensor 74, which is subsequently used as a switch to power on/off the infrared illuminators. When an aircraft is detected at night, the photo sensor is armed and powers on the infrared illuminators while the aircraft remains in the detection zone of the PIR sensor. Accordingly, power consumption is minimized and false events are practically eliminated because the infrared illuminators are only on and the camera can only “see” and respond to movement for the short duration of time while the aircraft is within the detection field of the PIR sensor. After capture, the photographs are relayed over wireless connection 20 to the server of the local station and recorded. The photographs are thereafter automatically transferred to the platform via the Internet connection. After the aircraft leave the detection zone, the system reverts to stand by status.

More particularly, in ongoing operation, the following series of events occur when an aircraft is detected. First, the PIR sensor detects the presence of an aircraft in its detection zone, and the output of the PIR sensor is used to activate power to the IR illuminators via the photo sensor. Next, the photo sensor powers on the infrared illuminators if the ambient light level is low, otherwise the infrared illuminators remain in their default off position. Then, the output of the PIR sensor is used to execute a script on the video encoder that enables detection of motion within a pre-defined detection zone within the field of view of the camera. Thereafter, when the video encoder detects movement within the pre-defined detection zone, it determines if the movement is related to an aircraft based on size and speed by measuring and calculating the number of pixels that move and the rate at which they move relative to the total number of pixels within the pre-defined detection zone. If the measured and calculated pixel movements meet pre-defined level criteria, the video encoder will consider that an aircraft is present and will start storing time stamped pictures internally and will send the pictures via wireless to the local site computer which then forwards them to the platform.

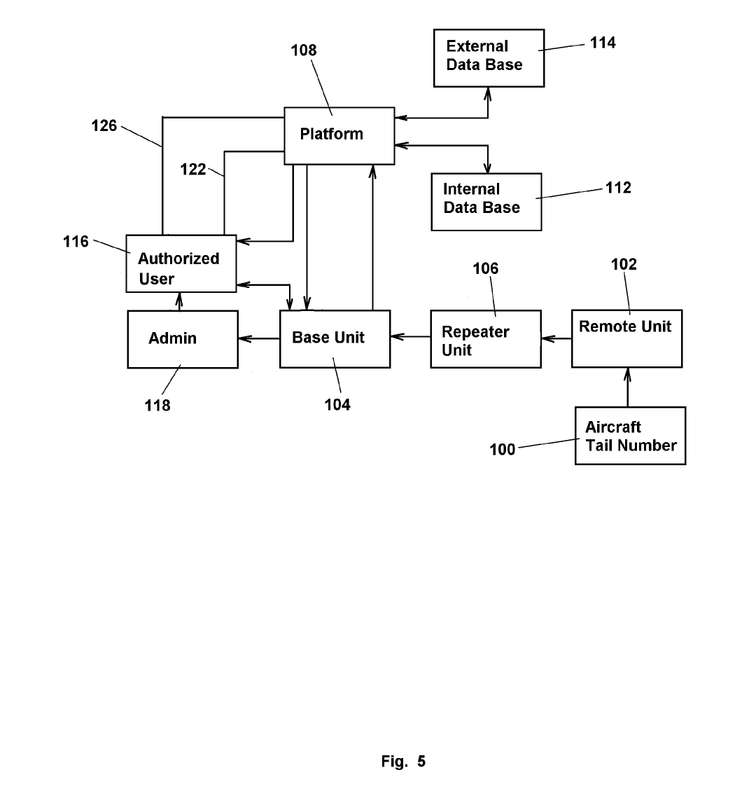

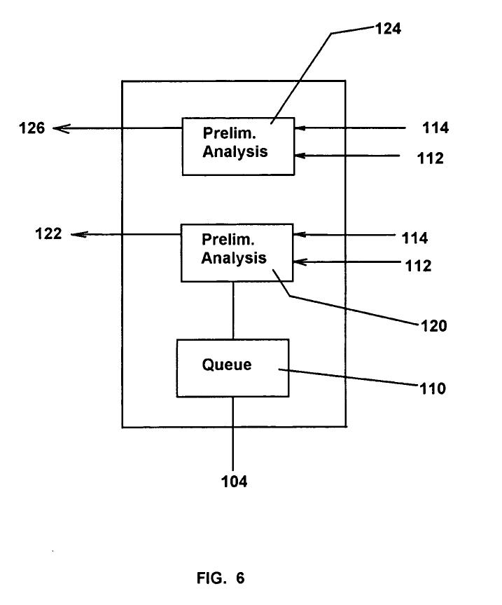

Referring to FIG. 5, upon detection and capture of an aircraft tail number 100 as described above the video is relayed from the remote unit 102 to the base unit 104 through a repeater unit 106, if any. The video is then uploaded to the platform 108 to a queue 110 for analysis and recording. For security surveillance, the platform 108 is coupled with an internal database 112 compiled at the platform and an external database 114 compiled by regulatory agencies such as the FAA. In the system, the operator of the base unit designates one or more authorized users 116 under the control of an administrator 118. The administrator 118 may authorize access to all or discrete portions of the platform. For monitoring, each user, separately or collectively, provides to the platform a compilation of aircraft and/or identification criteria constituting the user's watch list. Such a compilation may include for each aircraft the tail number registration and/or location, type of aircraft, manufacturer, model, engine type and location, tail configuration, wing configuration, landing gear location and the like. Referring additionally to FIG. 6, while in the queue, a preliminary analysis 120 is performed using photographic recognition software and the recognized specifics of the video compared with the databases. If a predetermined match certainty is determined, a preliminary alert 122 is issued to the user. If the certainty cannot be achieved or is negated by then prevailing conditions such as weather or illumination, no preliminary alerts are issued at this level.

When the aircraft arrives at the head of the queue, operators perform an identification analysis 124 by further analyzing video images, and determining and recording the tail number and other aircraft parameters, confirming or revising preliminary determinations as necessary. The determinations are compared against the databases and if a match is detected based on the user's watch list, a formal alert 126 is issued to the user. If the detected aircraft is not presently in the internal or external databases, the specifics are entered in the internal database. If available and part of the overall airport system through ancillary cameras, live video feeds are then made available to the user and authorized associates.

Based on the periodic activity, the platform will send reports to the airport on recorded traffic activity, by tail number identification, owner and address, basing information (transient or resident), arrival and departure times and dates, and other specifics desired by the airport. Such accounting of activities may then be used for documenting activity for the purposes of funding and grants, landing fees, marketing activities, and the like.

Such video may also be used for noise abatement and control. For instance, in the event noise complaints are received by the airport facility regarding excessive aircraft noise, usually time, date and location are provided. The facility may then direct a search at the platform to identify potential aircraft involved. Using the provided information, the facility can investigate and seek to resolve the matter in accordance with its procedures therefor.

It will be appreciated that the foregoing system addresses two main purposes; provide a tool for airport surveillance, safety and law enforcement and provide a database of valuable information that can be used by airport operators and stakeholders to benefit their businesses. As a result, the system provides major benefits:
Reports stolen and unregistered aircraft to TSA/FAA
Sends alert notifying law enforcement of suspicious aircraft and flight activity
Sends notification of aircraft on non-active and/or non-assigned runway
Closes flight plan on arrival or sends notification of flight plan deviation
Distinguishes between home-based and transient aircraft
Provides video identification of aircraft to assist first responders in locating target
Integrates with other databases to fill knowledge gaps in law enforcement
Alerts law enforcement to increase the probability of interdiction
Documents runway safety incursions and surface conditions
Aircraft is identified by using sources such as FAA database information

Having thus described a presently preferred embodiment of the present invention, it will now be appreciated that the objects of the invention have been fully achieved, and it will be understood by those skilled in the art that many changes in construction and widely differing embodiments and applications of the invention will suggest themselves without departing from the sprit and scope of the present invention. The disclosures and description herein are intended to be illustrative and are not in any sense limiting of the invention, which is defined solely in accordance with the following claims.

What is claimed:

1. A system for identifying on a continuous basis by tail number aircraft traveling along a pathway at an airport facility, comprising: means positioned adjacent said pathway for detecting the presence of an aircraft on the pathway within a detection zone; means for illuminating the aircraft on the pathway within said detection zone responsive to said detecting if ambient lighting is below a predetermined level; means for video recording the aircraft including the tail number of the detected aircraft; and means for transferring said recording to a remote facility for storage and analysis.

2. A detection system for alpha-numeric tail numbers on aircraft traveling a detection location on a path at a facility indicative of a departure or arrival of the aircraft, said detection system comprising:
a camera unit directed at said path for photographing the tail number of the aircraft at said detection location;
motion detection means for detecting the aircraft on the path prior to said detection location;
light detection means for determining light conditions at said detection location;
illumination means associated with said light detection means and said motion detection means for providing illumination of aircraft detected by said detection means if said light conditions are below a predetermined level;
control means for enabling said camera unit for capturing a series of photographic images of said aircraft and associated tail number as the aircraft traverses said detection location; and
means for wireless transmission of said images to a remote location for processing.

3. The detection system as recited in claim 2 wherein said motion detection means identifies aircraft on the basis of size and speed and thermal signature.

4. The detection system as recited in claim 3 wherein said illumination means includes comprises at least one source of infrared illumination.

5. The detection system as recited in claim 4 wherein said at least one source is associated with said camera unit.

6. The detection system as recited in claim 2 wherein said images include the time of said capturing.

7. A surveillance system for notifying an authorized party of the presence of an aircraft on an itemized list at a detection location on a path at an airport facility, said surveillance system comprising:
means for obtaining a video image of the aircraft at the detection location;
means for transmitting said video image to a monitoring location;
means at said monitoring location for determining based on the video image if the aircraft may be on the itemized list, and if present on the itemized list notifying the authorized party.

8. The surveillance system as recited in claim 7 wherein said itemized list includes identifying indicia and physical characteristics regarding the aircraft thereon and said determining is based on a comparison of said video image with said identifying indicia and physical characteristics.

9. The surveillance system as recited in claim 8 wherein said identifying indicia and physical characteristics includes at least a partial designation of the alpha-numeric tail number and physical characteristics of the aircraft.

10. The surveillance system as recited in claim 9 wherein the itemized list includes the alpha-numeric tail numbers and physical characteristics of various aircraft and said video image includes the alpha-numeric tail number and physical characteristics of the aircraft therein and wherein said authorized party is notified if there is a complete correspondence between the aircraft at the facility and the aircraft on the itemized list.

11. The surveillance system as recited in claim 10 wherein said means for obtaining a video image is at least one remote unit located at a location at the facility indicative of an arrival and/or departure of the aircraft and said video image includes a time said video image was obtained.

12. The surveillance system as recited in claim 11 including means including a first sensor associated with said remote unit for illuminating said aircraft if the ambient lighting at said location is below a predetermined level.

13. The surveillance system as recited in claim 12 including a second sensor associated with said remote unit for providing wherein said illuminating is provided only when the aircraft is within a predetermined range of said location.

14. The surveillance system as recited in claim 13 wherein a plurality of remote units are located at the facility at positions assuring that at least one video image is obtained of aircraft arriving at or departing from the facility.

15. The surveillance system as recited in claim 3 wherein said itemized list is prepared by an entity associated with said airport and the authorized party is designated by said entity.

16. The surveillance system as recited in claim 14 including a base unit associated with the facility and the video images are transferred from said remote units to said base unit, said base unit includes means for transferring said images to said monitoring location.

17. The surveillance system as recited in claim 14 including a plurality of facilities with associated base units and wherein said monitoring location sequentially processes said video images.

18. A method for identifying discrete aircraft arriving at or departing from an aircraft facility comprising the steps of:
preparing a listing of aircraft alphanumeric tail numbers;
acquiring individual video images of the tail numbers of aircraft arriving at or departing from the aircraft facility; and
transmitting said video images to a monitoring facility for analyzing based on said video images.

19. The method as recited in claim 18 wherein said analyzing of said video images at said monitoring facility determine aircraft having a tail number in said listing.

20. The method as recited in claim 19 including notifying by the monitoring facility to an authorized party of each aircraft having a tail number in said listing based on said analyzing.

21. The method as recited in claim 20 wherein said listing is an alert list comprised of aircraft suspected of involvement in illegal activities.

22. The method as recited in claim 15 wherein said listing includes tail numbers of aircraft and/or unique physical characteristics based at said facility.

23. The method as recited in claim 18 including illuminating the aircraft during said acquiring if light conditions are below a predetermined level.

24. A monitoring system for documenting arrivals and departures of aircraft from a facility comprising: a plurality of video recording means at said facility at locations corresponding to available arrival and departure sites; means for detecting the aircraft moving toward said site; light detection means for determining light conditions at said detection location; illumination means associated with said light detection means and said motion detection means for providing illumination of aircraft detected by said detection means if said light conditions are below a predetermined level; control means for enabling said camera unit for capturing a series of photographic images of said aircraft and associated tail number as the aircraft traverses said detection location; means for wireless transmission of said images to a remote location for processing; and means at said remote location for analyzing said images and providing said facility with documentation of the tail numbers physical characteristics of aircraft arriving and departing said facility on periodic intervals.

25. The monitoring system as recited in claim 24 wherein said documentation distinguishes between aircraft based at said facility on aircraft transient to said facility.
